(19) United States
(12) Patent Application Publication
(10) Pub. No.: US 2013/0223601 A1
(43) Pub. Date: Aug. 29, 2013

(54) TERMINAL, SERVICE SYSTEM AND CONTROL METHOD FOR PROVIDING MESSAGE COMMUNICATION FUNCTION WHILE CALLING

(71) Applicant: Tae Sook LEE, Seoul (KR)

(72) Inventor: Tae Sook LEE, Seoul (KR)

(21) Appl. No.: 13/468,225

(22) Filed: May 10, 2012

(30) Foreign Application Priority Data
Feb. 28, 2012 (KR) 10-2012-0020477

(51) Int. Cl. H04M 11/00; H04M 1/64

(52) U.S. Cl. 379/88.13; 379/88.22

(57) ABSTRACT

The present invention relates to a terminal, a service system and a control method for providing a message communication function while calling. The service system comprises a call control system for controlling, when call connection is requested by a first terminal, the call connection between the first terminal and a second terminal corresponding to a receiving number; a media system for providing a call service in a state where the call connection is achieved; and a message system for processing, when transmission of a message is requested by the first terminal while the call service is being provided by the media system, the message.

### CROSS-REFERENCE TO RELATED APPLICATION

This patent application claims the benefit of priority from Korean Patent Application No. 10-2012-0020477, filed on Feb. 28, 2012, the entire disclosure of which is incorporated herein by reference.

### FIELD OF THE INVENTION

The present invention relates to a terminal and a service system; and, more particularly, to a terminal, a service system and a control method for providing a message communication function while calling.

### BACKGROUND OF THE INVENTION

In general, with the development of the electronics and telecommunications technology, various electronic appliances are being manufactured and various devices such as a computer, a tablet PC, a cellular phone, a smart phone, a media player and the like are being widely used.

Especially, portable devices such as a cellular phone, a smart phone, a tablet PC and the like are provided with a message service and a media service from a communication company.

Herein, the media service includes a video call and a voice call; and the message service includes a short message, a multimedia message and the like.

The communication company has a message system and a media system in order to provide the corresponding services.

Meanwhile, in conventional portable terminals, services other than calling cannot be used while calling. Further, in some conventional cases, a user did not need to use other services while calling. However, terminals that have been recently developed have various functions and allow multitasking in which various functions are carried out simultaneously. Moreover, as the diversification of the society is advanced, a user needs to send a text message while voice calling or video calling. For example, a user may need to send a message to a counterpart or a third party while calling, and may also need to reply to the received message while calling. However, it is currently difficult to perform such functions because a three- or four-step interaction is required. Besides, it is inconvenient for a user to use such functions because the user is concerned that the call is disturbed or disconnected by implementing such functions while calling.

### SUMMARY OF THE INVENTION

In view of the above, the present invention provides a terminal, a service system, and a control method for providing a message communication function while calling.

In accordance with one aspect of the present invention, a service system for providing a call service and a message service to at least one terminal connected thereto through a wire/wireless network, comprises:

a call control system for controlling, when call connection is requested by a first terminal, the call connection between the first terminal and a second terminal corresponding to a receiving number;

a media system for providing a call service in a state where the call connection is achieved; and

a message system for processing, when transmission of a message is requested by the first terminal while the call service is being provided by the media system, the message.

In accordance with one aspect of the present invention, the message service and the call service are provided through the same channel.

In accordance with one aspect of the present invention, the message service and the call service are provided through different channels.

In accordance with one aspect of the present invention, the message includes a text message and a multimedia message.

In accordance with one aspect of the present invention, the terminal includes:

an input unit through which a user's selection is input;

a display unit for displaying information;

a communication unit for performing a communication function; and

a control system for requesting the serving system to provide, when a message transmission function is selected by the input unit while calling, a message transmission screen to the display unit and to transmit, when a message is input and the message transmission function is selected, the message to a message receiving number.

In accordance with another aspect of the present invention, a terminal to which a call service and a message service are provided through a service system, comprises:

an input unit through which a user's selection is input;

a display unit for displaying information;

a communication unit for performing a communication function; and

a control system for requesting the serving system to provide, when a message transmission function is selected by the input unit while calling, a message transmission screen to the display unit and to transmit, when a message is input and the message transmission function is selected, the message to a message receiving number.

In accordance with another aspect of the present invention, the control unit requests the service system to display, when a message is received while calling, the received message on the display unit and to transmit, when a reply message is input and the message transmission function is selected, the reply message to an originating number of the received message.

In accordance with another aspect of the present invention, a terminal control method comprises:

determining, by a control unit, whether or not a message function is selected while calling;

providing, by the control unit, a message input screen when the message function is selected by the input unit;

inputting a message by using the input unit and determining, by the control unit, whether or not a message transmission function is selected; and

requesting, by the control unit, the service system to transmit the message when the message transmission function is selected.

In accordance with another aspect of the present invention, the terminal control method may further comprises:

determining, by the control unit, whether or not a message is received while calling;

displaying on a display unit, when the message is received, the received message and a screen for writing a reply message;

inputting a message by using the input unit and determining, by the control unit, whether or not a message transmission function is selected; and

requesting, by the control unit, the service system to transmit the message when the message transmission function is selected.

In accordance with the embodiment of the present invention, a user can check a message received while calling without an additional operation and send a message to a desired party, so that convenience can be provided to the user.

Further, in accordance with the embodiment of the present invention, a user can check a received message and send a reply message while calling. Accordingly, an operation of sending an urgent message is not delayed by a call, and a desired message can be immediately sent while calling.

### BRIEF DESCRIPTION OF THE DRAWINGS

FIG. 1 is a diagram of a service system in accordance with an embodiment of the present invention.

FIG. 2 is a block diagram showing a terminal in accordance with an embodiment of the present invention.

FIG. 3 is an operation flowchart of a service method in accordance with an embodiment of the present invention.

FIG. 4 is an operation flowchart of a method for controlling an operation of sending of a message while calling in a terminal in accordance with an embodiment of the present invention.

FIGS. 5 and 6 show examples of a screen for displaying the operation in the terminal shown in FIG. 4.

FIG. 7 is an operation flowchart of a method for controlling an operation of receiving a message while calling in a terminal in accordance with an embodiment of the present invention.

FIG. 8 shows an example of a screen for displaying the operation in the terminal shown in FIG. 7.

### DETAILED DESCRIPTION OF THE INVENTION

Hereinafter, embodiments of the present invention will be described in detail with reference to the accompanying drawings so that those skilled in the art to which the present invention pertains can easily realize the preset invention. However, the present invention can be realized in various forms without being limited to the following embodiments. In order to clearly explain the present invention, portions that are not related to the explanation are omitted in the drawings. Further, throughout the specification, like reference numerals refer to like parts.

Throughout the specification, the term “include” and similar terms are to be understood to imply the inclusion of other elements, and not to exclude other elements unless the context clearly dictates otherwise.

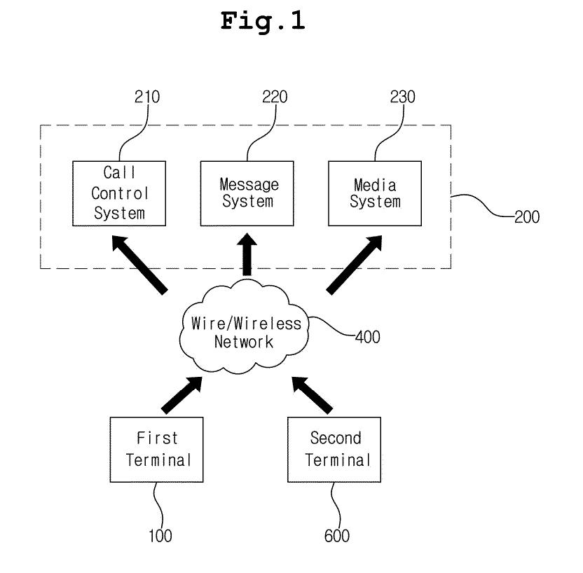

FIG. 1 is a diagram of a service system in accordance with an embodiment of the present invention.

Referring to FIG. 1, the service system in accordance with an embodiment of the present invention includes a service system 200 for providing a message service and a voice call service to a first and a second external terminal 100 and 600. The service system 200 has a call control system 210, a message system 220, and a media system 230.

The call control system 210 connects communication between the first terminal 100 and the second terminal 600 by controlling a call in accordance with requests of the first and the second terminal 100 and 600. Since channel assignment or session assignment is known in this field, the detailed description thereof will be omitted.

The message system 220 performs a function of sending and receiving a text message or a multimedia message between different terminals. The message system 220 performs a function of sending and receiving a text message or a multimedia message especially between the first terminal 100 and the second terminal 600 or between one of the first and the second terminal 100 and 600 and another terminal. The message communication function is carried out even when the first terminal 100 and the second terminal 600 are in a call mode.

When the media session is assigned to the first and the second terminal 100 and 600 by the call control system 210, the media system 230 provides a voice service and an image service between the first and the second terminal 100 and 600 through the media session.

The message system 220 and the media system 230 can be integrated, if necessary. Further, a bi-directional message service can be provided by extending the media session. Herein, a plurality of second terminals 600 may be provided. In that case, the first terminal 100 may communicate with a plurality of second terminals 600.

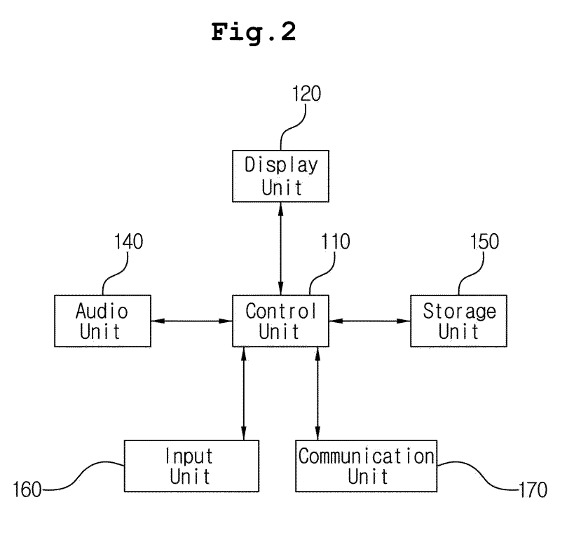

Hereinafter, the configuration of the terminal will be described with reference to FIG. 2. Since the first and the second terminal 100 and 600 have the same configuration, the configuration of one of the first and the second terminal 100 and 600 will be described as a representative example.

Herein, the terminal may be configured as a computer, a tablet PC, a cellular phone, a smart phone, a media player or the like.

FIG. 2 is a diagram of a terminal in accordance with an embodiment of the present invention.

Referring to FIG. 2, the terminal in accordance with an embodiment of the present invention includes a control unit 110, a display unit 120, an audio unit 140, a storage unit 150, an input unit 160, and a communication unit 170.

The input unit 160 may include a keyboard, a keypad, a mouse or the like. The input unit 160 may preferably be a touch screen or a touch pad.

The display unit 120 for displaying information displays a screen for sending and receiving a text message while calling.

The communication unit 170 performs a communication function in a CDMA, a GSM, or another wireless mode.

The storage unit 150 stores therein various information such as contact information, previously received messages, moving pictures, music files and the like. The storage unit 150 may also store therein control programs.

The audio unit 140 outputs a bell sound or an alarm sound, or transfers received voice to the control unit 110.

The control unit 110 controls a call. When message transmission is selected by the input unit 160 while calling, the control unit 110 provides a message transmission screen on the display unit 120. When a message is input and the message transmission is selected, the control unit 110 requests the service system 200 to transmit the message to a message receiving number. In addition, when a message is received while calling, the control unit 110 displays the received message on the display unit 120. When a reply message is input and the message transmission is selected, the control unit 110 requests the service system 200 to transmit the reply message to the originating number of the received message.

The operation of the service system configured as described above will be described hereinafter.

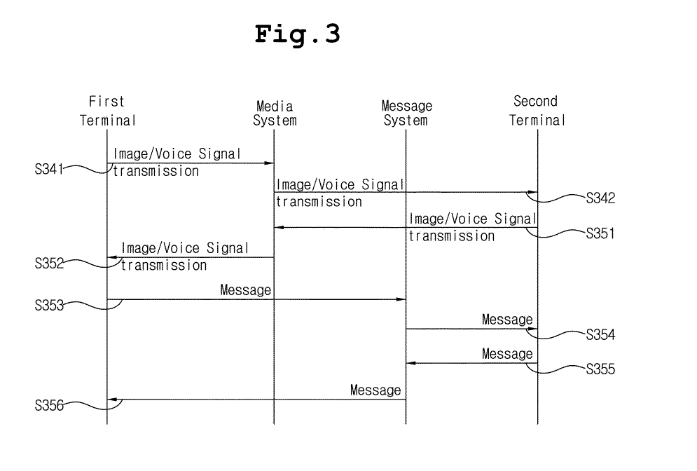

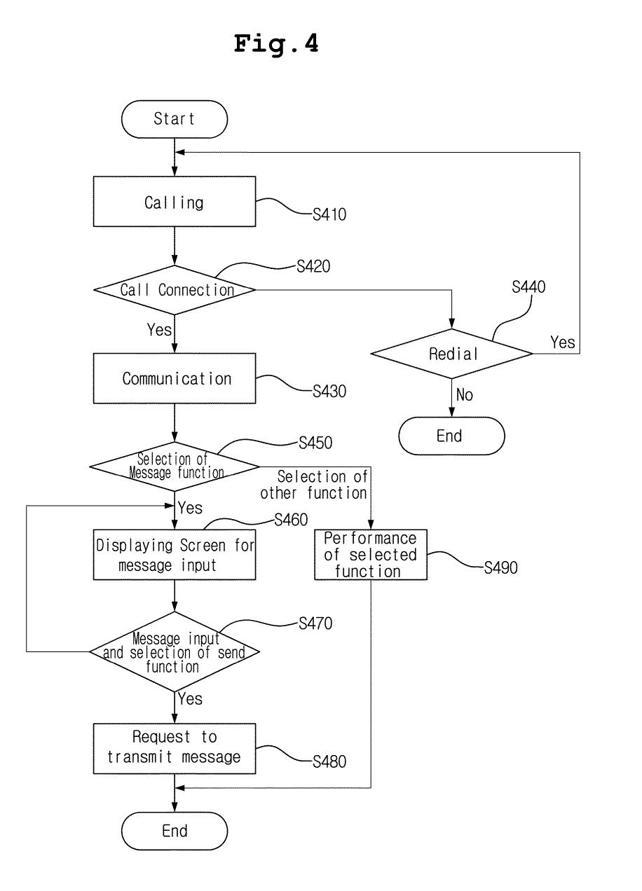

FIG. 3 is an operation flowchart of a service system in accordance with an embodiment of the present invention.

Referring to FIG. 3, when a user of the first terminal 100 wants to communicate with a user of the second terminal 600, call connection is requested to the call control system 210 by manipulating the first terminal 100.

Then, the call control system 100 connects the communication between the first and the second terminal 100 and 600 by controlling a call in accordance with the request of the first terminal 100. In other words, the first and the second terminal 100 and 600 participate in sessions, and the call control system 100 assigns the sessions to the first and the second terminal 100 and 600. Accordingly, the first and the second terminal 100 and 600 can communicate with each other through a predetermined protocol.

In this state, the user of the first terminal 100 and the user of the second terminal 600 communicate with each other freely.

When the first terminal 100 receives an image signal and a voice signal (S341), the media system 230 transfers the image signal and the voice signal to the second terminal 600 (S342).

Meanwhile, after the second terminal 600 receives the image signal and the voice signal from the first terminal 100 or transmits an image signal or a voice signal independently (S351), the media system 230 transfers the image signal and the voice signal to the first terminal 100 (S352).

When the first terminal 100 receives a message such as a text message or a multimedia message (S353), the message system 220 transfers the corresponding message to the second terminal 600 (S354).

Meanwhile, after the second terminal 600 receives the message from the first terminal 100 or transmits a message independently (S355), the message system 220 transfers the corresponding message to the first terminal 100 (S356).

The above processes can be carried out simultaneously. For example, the message, the voice information and the image information can be transmitted and received at the same time.

Hereinafter, a process in which the terminals 100 and 600 transmit and receive messages while calling will be described in detail.

First, when a user attempts a call by manipulating the input unit 160, the control unit 110 requests call connection to a phone number of an intended receiver, and the service system 200 connects the call as described above (S410).

When the call is connected (S420), the control unit 110 provides the communication function (S430). Meanwhile, when an intended receiver does not receive the call, the user redials the phone number of the intended receiver or terminates the call (S440).

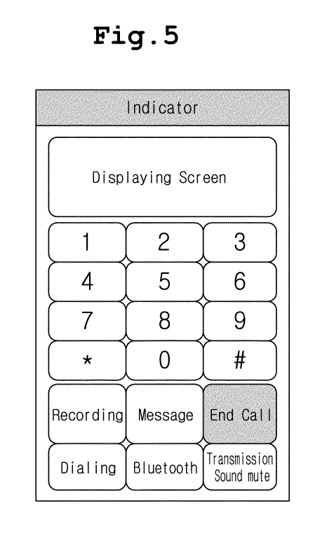

The control unit 110 displays the screen shown in FIG. 5 on the display unit 120 while calling. The screen can be variously modified, and different types of screens can be provided by different manufacturers. In the case of using a hands-free device, an earphone or the like while calling, the voice of the counterpart can be more easily heard.

Referring to FIG. 5, “End call” or “Message” can be selected, and other functions such as “Recording”, “Dialing”, “Bluetooth”, “Transmission sound mute” are provided additionally.

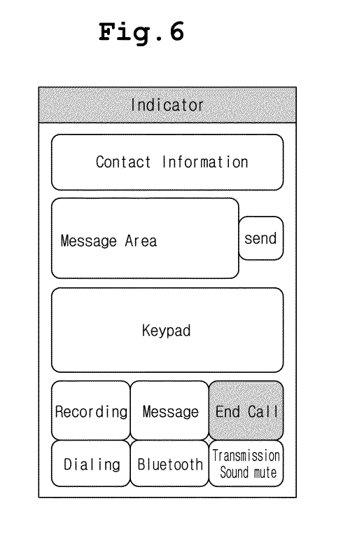

When a user selects “Message” (S450), the control unit 110 displays the screen shown in FIG. 6 on the display unit 120 (S460).

Then, the user inputs desired text by manipulating a keypad serving as the input unit 160, selects a desired receiver in the contact information, and then selects “Send” of the input text (S470). Next, the control unit 110 requests the service system 200 to transmit the input message (S480).

Thereafter, the service system 200 transmits the message to the corresponding receiver.

If necessary, a phone number of a counterpart can be basically displayed as the contact information.

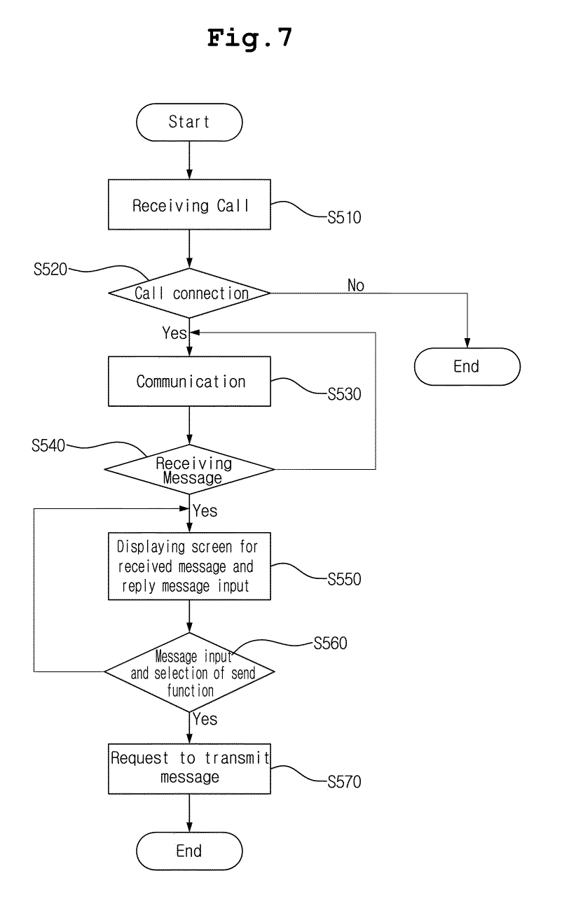

The case in which a message is received while calling will be described with reference to FIG. 7.

Referring to FIG. 7, when the call is received, the control unit 110 outputs a bell sound through the audio unit 140 (S510).

Then, if a user selects call connection (S520), the control unit 110 connects the call (S530). In that state, the control unit 110 provides the communication function, and the user communicate with a receiver through a voice call or a video call.

Meanwhile, when the receiver does not receive the call, the call connection attempt is terminated.

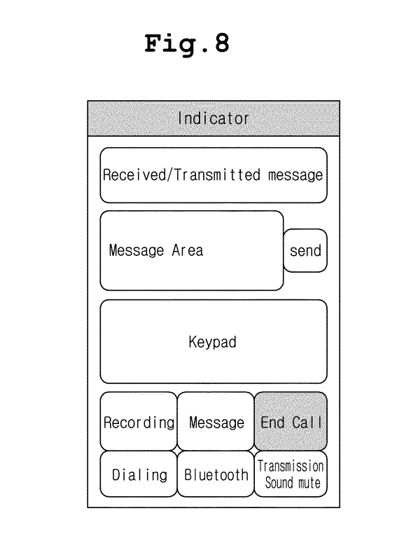

The control unit 100 determines whether or not a message is received while calling (S540). When a message is received, the control unit 100 displays on the display unit 120 the received message or a screen for writing a reply message. The example of such screen is illustrated in FIG. 8.

Referring to FIG. 8, contents of a received message and a transmitted message are additionally displayed on the screen shown in FIG. 6, and the user can send a reply message on that screen. When a user inputs desired text by manipulating a keypad serving as the input unit 160 and selects “Send” (S560), the control unit 110 requests the service system 200 to transmit the input message (S570).

Then, the service system 200 transmits the message to the sender of the received message. At this time, basically the phone number of the caller is basically as the contact information. However, the type of the contact information can be changed if necessary.

In the above processes, a caller and a callee can transmit and receive a text message to a counterpart or a third party if necessary, which improves the convenience of users.

Since it is possible to check a received message and transmit a reply message to the received message while calling, an operation of transmitting an urgent message is not delayed by a call, and a user can immediately send a desired message while calling.

The above-described embodiments of the present invention are not only realized by methods and devices, but also realized by a program or a recording medium storing the program for realizing the functions corresponding to the embodiments of the present invention, which will be easily realized by a person skilled in the art.

While the embodiments of the present invention have been described in detail, the scope of the present invention is not limited thereto, and covers numerous variations and modifications that can be made by those skilled in the art without departing from the basic concepts of the present invention defined by the following claims.

What is claimed is:

1. A service system for providing a call service and a message service to at least one terminal connected thereto through a wire/wireless network, comprising:
a call control system for controlling, when call connection is requested by a first terminal, the call connection between the first terminal and a second terminal corresponding to a receiving number;
a media system for providing a call service in a state where the call connection is achieved; and
a message system for processing, when transmission of a message is requested by the first terminal while the call service is being provided by the media system, the message.

2. The service system of claim 1, wherein the message service and the call service are provided through the same channel.

3. The service system of claim 1, wherein the message service and the call service are provided through different channels.

4. The service system of claim 1, wherein the message includes a text message and a multimedia message.

5. The service system of claim 4, wherein the terminal includes:
an input unit through which a user's selection is input;
a display unit for displaying information;
a communication unit for performing a communication function; and
a control system for requesting the serving system to provide, when a message transmission function is selected by the input unit while calling, a message transmission screen to the display unit and to transmit, when a message is input and the message transmission function is selected, the message to a message receiving number.

6. A terminal to which a call service and a message service are provided through a service system, comprising:
an input unit through which a user's selection is input;
a display unit for displaying information;
a communication unit for performing a communication function; and
a control system for requesting the serving system to provide, when a message transmission function is selected by the input unit while calling, a message transmission screen to the display unit and to transmit, when a message is input and the message transmission function is selected, the message to a message receiving number.

7. The terminal of claim 6, wherein the control unit requests the service system to display, when a message is received while calling, the received message on the display unit and to transmit, when a reply message is input and the message transmission function is selected, the reply message to an originating number of the received message.

8. A terminal control method comprising:
determining, by a control unit, whether or not a message function is selected while calling;
providing, by the control unit, a message input screen when the message function is selected by the input unit;
inputting a message by using the input unit and determining, by the control unit, whether or not a message transmission function is selected; and
requesting, by the control unit, the service system to transmit the message when the message transmission function is selected.

9. The terminal control method of claim 8, further comprising:
determining, by the control unit, whether or not a message is received while calling;
displaying on a display unit, when the message is received, the received message and a screen for writing a reply message;
inputting a message by using the input unit and determining, by the control unit, whether or not a message transmission function is selected; and
requesting, by the control unit, the service system to transmit the message when the message transmission function is selected.
